(19) United States
(12) Patent Application Publication
(10) Pub. No.: US 2013/0088055 A1
(43) Pub. Date: Apr. 11, 2013

(54) SAFETY SEAT

(71) Applicant: István Gubás, Zalaegerszeg (HU)

(72) Inventor: István Gubás, Zalaegerszeg (HU)

(21) Appl. No.: 13/583,766

(22) PCT Filed: Oct. 12, 2010
(86) PCT No.: PCT/HU2010/000109

§ 371 Date: Nov. 23, 2012

(30) Foreign Application Priority Data
Mar. 11, 2010 (HU) U1000058

(51) Int. Cl. B64D 25/02; B60N 2/427; B60N 2/42; B64D 11/06; B64D 25/04

(52) U.S. Cl. CPC B64D 25/02; B64D 11/06; B64D 25/04; B60N 2/42; B60N 2/427
USPC 297/216.1

(57) ABSTRACT

The safety seat according to the invention contains a lower fastening 5 structure (5), seat surface, squab and head support (9) and safety belt, and further it is provided with a casing (1) surrounding said seat surface (8), squab and head support (9), having an egg shape and being provided with a door (2) form-fitting on said casing (1) and rotatable in horizontal direction. The safety seat is provided with air-bags (10, 11) and there is a weakened part or a releasable lock 10 between the lower fastening structure (5) and the casing (1), releasing in answer to shock like load. (FIG. 1)

Object of the present invention is a safety seat to be used mainly in airplanes, for increasing the survival chance of passengers, the seat containing a lower fastening structure, seat surface, squab and head support and safety belt.

Throughout the world, more than 2.5 billion people fly yearly with airplanes, and—though the air-planes are the most safe vehicles carrying passengers—tragic accidents are regular. There are survivors in most cases (95% of the accidents), but there would still be possible to enhance the number of survivors, if the seats of the planes would have more safe construction, e.g. in cases if the plane runs out of the runway, or collision occurs on the earth. Similarly, there is a chance to increase the number of survivors, if the plane crashes immediately after take off, when the velocity of the vehicle is still not too high, or in the case of crash landing.

Accordingly, in considerable number of cases, passengers can survive the first impact, moreover, they may have several seconds or even minutes for taking action before the impact. In such cases, the most important thing is that the passengers must be held as close as possible.

WO 2007/068169 discloses a safe air-plane seat, wherein two air bags are provided, and these airbags surround the passenger perfectly.

In many cases, however, the passengers die due to the fire and smoke, and the airbags alone do not protect them from that.

Therefor, CN 2446062 offers a cylindrical lifesaving cabin composed of two hemispherical parts, wherein both part is provided with two seats. In case of accident, the parts can be folded into a full closed cylinder by foot switches. However, a cabin with four seats can not provide appropriate protection against mechanical injuries, as the room in the cabin is too big for the passengers, and there is too much possibility to move within the cabin, if there is a shock. The uncoordinated reaction of the passengers within the cabin may cause further problems in case of an accident.

Therefor, object of the present invention is to provide a safe personal seat for passengers, mainly in airplanes, which eliminates the problems of the prior seats, and which enables to put down the passenger-fatality rate during accidents.

According to the invention, a safe personal seat is provided, which contains a lower fastening structure, seat surface, squab and head support and safety belt, wherein the seat is provided with a casing surrounding said seat surface, squab and head support and having an egg shape and being provided with a door form-fitting on said casing and rotatable in horizontal direction.

The seat is preferably provided with at least two side air-bags and a front air bag arranged in the door, and in certain cases with an upper air-bag.

The air-bags may be driven with compressed air cartridges or may be connected to a compressed air container arranged below the seat and preferably connected to the compressed air system of the air-plane, via the lower fastening structure.

In an advantageous embodiment of the safety seat according to the invention, the door rotatable in horizontal direction is pivoted centrally on the top of the casing and is guided in a rail at the lower part of the casing. The door may be provided with a lock to be opened from inside—and in some cases from outside as well.

The casing of the safety seat is preferably made of shockproof plastic and is provided with heat insulating lining.

In another embodiment the safety seat there is a releasable lock between the lower fastening structure and the casing, releasing in answer to shock like load or, alternatively, there is a weakened part between the lower fastening structure and the casing, breaking in answer to shock like load. Preferably there is an arcuate rail between the lower fastening structure and the casing.

In many cases it is important that the seat is provided with means for optical and/or radio signal transmitting means.

The invention is based on the recognition that the number of victims of air-plane crushes may be considerably reduced, if all passengers have a separate, closed personal safety seat, wherein they are surrounded with a shockproof, well sealed casing during the accident, and are closely held in place by air bags from all sides.

Further details and advantages of the invention will be explained hereinafter according to a preferred embodiment, provided only to an exemplificative and non limiting purpose with reference to the annexed drawing, wherein

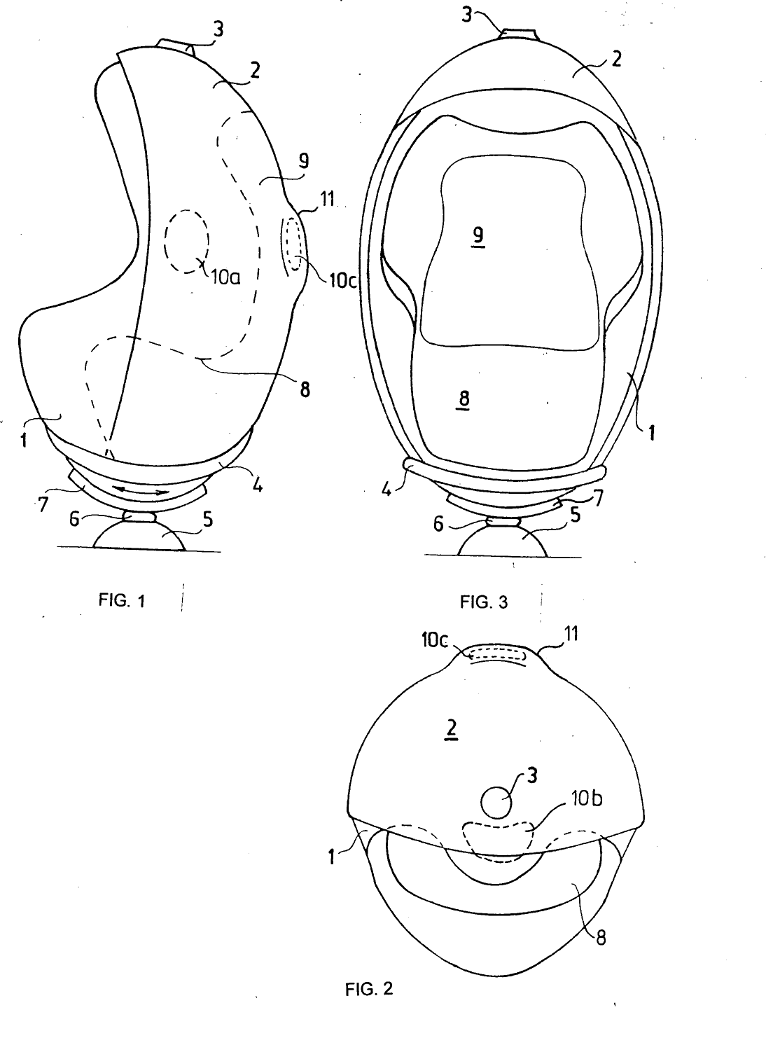

FIG. 1 is side view of the safety seat of a preferred embodiment of the present invention,

FIG. 2 is the top view of the safety seat in FIG. 1. and

FIG. 3 is the front view of the safety seat in FIG. 1.

The most important part of the safety seat according to the present invention shown in the Figures is a casing 1, which, together with door 2, provides a safe, egg shaped cabin for a single passenger. Door 2 follows the shape of casing 1 and is rotatable fixed with bearing 3 on the top of the cabin. At the bottom of the cabin, it is guided in rail 4 fixed on the casing and closes the cabin safely.

Casing 1 is connected to the structure of the air-plane by fastening structure 5. This structure relieves the structure of the air-plane and can move freely if shock like effect of a predetermined force occurs. Another possibility is to provide a weakened part 6 between the fastening structure and the casing, which will break if shock like effect of a predetermined force occurs.

Casing 1 is preferably made of shockproof plastic and is provided with heat insulating lining. The casing is connected to the fastening structure with an arcuate rail 7, which enables tilting the seat with respect to the fastening structure, as shown by the arrow in FIG. 1.

The seat is arranged within the casing 1 and is provided with a seat surface, squab and head support 9 and safety belt. Air bags 10a, 10b are also arranged within the casing, preferably on both sides and overhead as well. It is advantageous if the door 2 is also provided with an air bag 10c in a nest 11 opposite to the passenger, when door 2 is closed. The air bags 10a, 10b, 10c may be driven with compressed air cartridges or may be connected to a compressed air container arranged below the seat.

The container may be connected to the compressed air system of the airplane, via the lower fastening structure 5.

It is also advantageous to provide the safety unit with means for optical and/or radio signal transmitting for tracing it after the accident.

The safety lifesaving seat according to the invention provides protection of the passengers during accident of explosion or crash. Upon noticing the danger, the passenger can close and lock the door of the casing immediately. The activated airbags keep the passenger motionless within the casing; meanwhile the impact resistant wall of the casing protects him. Upon shock, the casing disjoins the fastening structure and can leave the damaged air-plane.

The casing may be provided with a usual oxygen mask for protecting the passenger against smoke and fire.

The seat with squab and head support ensures a comfortable journey and rail 7 enables tilting the seat as well. Arm rests and the usual illumination, loudspeaker and alarm-bell may also be provided within the casing.

The lifesaving seat according to the invention considerably enhances the safety of the passengers and enables reducing the passenger-fatality rate during accidents.

1. Safety seat, preferably for air-planes, the seat containing a lower fastening structure (5), seat surface, squab and head support and safety belt, characterized in that it is provided with a casing (1) surrounding said seat surface (8), squab and head support (9), having an egg shape and being provided with a door (2) form-fitting on said casing (1) and rotatable in horizontal direction.

2. Safety seat as claimed in claim 1, characterized in that it is provided with air-bags (10, 11).

3-4. (canceled)

5. Safety seat as claimed in claim 2, characterized in that the air-bags (10, 11) are driven with compressed air cartridges.

6. Safety seat as claimed in claim 2, characterized in that the air-bags (10, 11) are connected to a compressed air container arranged below the seat.

7. Safety seat as claimed in claim 6, characterized in that the container is connected to the compressed air system of the air-plane, via the lower fastening structure (5).

8. Safety seat as claimed in claim 1, characterized in that the door (2) is held by a bearing (3) arranged centrally on the top of the casing (1).

9. Safety seat as claimed in claim 6, characterized in that the door (2) rotatable in horizontal direction is guided in a rail (7) at the lower part of the casing (1).

10. Safety seat as claimed in claim 6, characterized in that the door (2) is provided with a lock to be opened from inside—and in some cases from outside.

11. Safety seat as claimed in claim 1, characterized in that the casing (1) is made of shockproof plastic.

12. Safety seat as claimed in claim 1, characterized in that the casing (1) is provided with heat insulating.

13. Safety seat as claimed in claim 1, characterized in that there is a weakened part between the lower fastening structure (5) and the casing (1), releasing in answer to shock like load.

14. Safety seat as claimed in claim 1, characterized in that there is a releasable lock between the lower fastening structure (5) and the casing (1), breaking in answer to shock like load.

15. Safety seat as claimed in claim 1, characterized in that there is an arcuate rail (7) between the lower fastening structure (5) and the casing (1).

16. Safety seat as claimed in claim 1, characterized in that it is provided with means for optical and/or radio signal transmitting.
